(19) United States
(12) Patent Application Publication
(10) Pub. No.: US 2018/0026890 A1
(43) Pub. Date: Jan. 25, 2018

(54) TWO STEPS SERVER SELECTION MECHANISM

(71) Applicant: Lenovo Enterprise Solutions (Singapore) Pte. Ltd., Singapore (SG)

(72) Inventors: Corneliu-Ilie Calciu, Bucharest (RO); Radu Mihai Iorga, Bucharest (RO)

(21) Appl. No.: 15/214,950

(22) Filed: Jul. 20, 2016

(51) Int. Cl. H04L 12/803; H04L 29/08; H04L 12/24

(52) U.S. Cl. CPC H04L 47/125; H04L 41/0896; H04L 67/10

(57) ABSTRACT

A method includes a local electronic device submitting a request to a service provider server for delivery of specific content to the local electronic device, the local electronic device receiving a reply from the service provider server identifying a plurality of content servers that can each deliver the requested content over a network, and the local electronic device determining local context parameters about its network connection with each of the identified content servers. The local electronic device may then select one of the content servers from which to receive the requested content, wherein the selected content server is associated with a local context parameter indicating that the local electronic device has a better network connection with the selected content server than with any of the other identified content servers. The local electronic device may then download the requested content from the selected content server.

### BACKGROUND

### Field of the Invention

The present invention relates to services that deliver requested content to end user devices and methods of determining how to deliver the requested content to the end user device.

### Background of the Related Art

The Internet is a global communications network that enables communication between computers and other special purpose electronic devices over large areas and distances. Service providers may utilize the Internet as a medium for delivering digital content to end users. An end user device may request content using a browser, an application (“app”), or specialized hardware. The content itself may vary widely depending upon the service provider's offerings and the end user's interests or demands. However, audio or video content may be streamed from the service provider to the end user device over the Internet.

The popularity of online content has risen to the point that a service provider will typically use a large number of content servers for the delivery of content to a large number of end user devices. Accordingly, the service provide may maintain a uniform interface for interaction with the end user device, but then select one of the available content servers from which to transmit the requested content to the end user device. For example, if an end user device has requested streaming delivery of a specific movie, the service provider server will select one of several content servers having the requested movie and stream the content to the end user device from the selected content sever. If the selected content server becomes overloaded, the content server may either reduce the quality or resolution of the content being delivered or initiate a switch to another of the available content servers.

### BRIEF SUMMARY

One embodiment of the present invention provides a method comprising a local electronic device submitting a request to a service provider server for delivery of specific content to the local electronic device, the local electronic device receiving a reply from the service provider server identifying a plurality of content servers that can each deliver the requested content over a network, and the local electronic device determining one or more local context parameters about a network connection between the local electronic device and each of the identified content servers. The method further comprises the local electronic device selecting a content server from among the plurality of content servers from which to receive the requested content, wherein the selected content server is associated with a local context parameter indicating that the local electronic device has a better network connection with the selected content server than with any of the other identified content servers, and the local electronic device downloading the requested content from the selected content server.

Another embodiment of the present invention provides a computer program product comprising a non-transitory computer readable storage medium having program instructions embodied therewith, wherein the program instructions are executable by a processor to cause the processor to perform a method. The method comprises a local electronic device submitting a request to a service provider server for delivery of specific content to the local electronic device, the local electronic device receiving a reply from the service provider server identifying a plurality of content servers that can each deliver the requested content over a network, and the local electronic device determining one or more local context parameters about a network connection between the local electronic device and each of the identified content servers. The method further comprises the local electronic device selecting a content server from among the plurality of content servers from which to receive the requested content, wherein the selected content server is associated with a local context parameter indicating that the local electronic device has a better network connection with the selected content server than with any of the other identified content servers, and the local electronic device downloading the requested content from the selected content server.

### BRIEF DESCRIPTION OF THE SEVERAL VIEWS OF THE DRAWINGS

FIG. 1 is a system diagram including an end user, service provider and multiple content servers in communication over a network.

FIG. 2 is a system diagram illustrating various communications between the end user, service provider and multiple content servers according to one embodiment of the present invention.

FIG. 3 is a diagram of a computer capable of serving as the service provider, the content server or an end user device for implementing embodiments of the present invention.

FIG. 4 is a flowchart of a method according to an embodiment of the present invention.

### DETAILED DESCRIPTION

One embodiment of the present invention provides a method comprising a local electronic device submitting a request to a service provider server for delivery of specific content to the local electronic device, the local electronic device receiving a reply from the service provider server identifying a plurality of content servers that can each deliver the requested content over a network, and the local electronic device determining one or more local context parameters about a network connection between the local electronic device and each of the identified content servers. The method further comprises the local electronic device selecting a content server from among the plurality of content servers from which to receive the requested content, wherein the selected content server is associated with a local context parameter indicating that the local electronic device has a better network connection with the selected content server than with any of the other identified content servers, and the local electronic device downloading the requested content from the selected content server.

The local electronic device may be any type of electronic device that downloads content from a content server. For example, the electronic device may be a laptop computer, desktop computer, tablet computer, mobile phone, cable television set top box, smart wearable device, smart appliance, and the like. Similarly, the requested content may be or include, without limitation, audio, video, images, application software, a software update, and the like. Preferably, the service provider server is accessible over the network and provides an interface that allows a user of the local electronic device to view a list of available content and request one or more selected content items to be downloaded. As used herein, the term “download” includes “streaming” and other forms of data transfer. Furthermore, the communication and data transfer between the local electronic device, service provider server and the content servers is not limited to any specific communication protocol and may occur over one or more networks or network topologies.

In a further embodiment, the reply from the service provider server may identify one or more content servers that can each deliver the requested content and that also have a lower load than other content servers that can deliver the requested content. Accordingly, the content servers identified in the reply may be filtered on the basis of the dual criteria of having the content available and have a lower load than the other content servers. The load on a content server may be indicated by a parameter selected from, without limitation, CPU load, memory load, network card load, and a number of active processes. The method may optionally include additional criteria for selecting content servers to identify in the reply from the service provider server to the electronic device. Furthermore, the electronic device may select a content server from which to receive the requested content, wherein the selected content server is associated with a local context parameter and a server load parameter indicating that the local electronic device has a better network connection with the selected content server than with any of the other identified content servers

In another embodiment, the local electronic device obtains a server context parameter, such as a content server load, for each of the plurality of content servers. For example, the local electronic device may receive the server context parameter for each of the plurality of content servers from the service provider server. The server context parameter is typically dynamically changing, but is an indicator of the current operating condition of a content server.

Optionally, the one or more local context parameters may be selected from a measure of “round trip time” between the local electronic device and the content server, a “hop count” of devices between the local electronic device and the content server, and a combination thereof. “Round trip time” may be an amount of time that is required for a signal to be communicated from the electronic device to the content server and back to the electronic device, or from the content server to the electronic device and back to the content server. The amount of “round trip time” is generally expected to have an inverse relationship with the quality of the network connection between the electronic device and the content server. A “hop count” may be a number of times that a signal or message must be transmitted by a first entity and received by another entity before the signal or message has traversed from the electronic device to the content server or from the content server to the electronic device. The “hop count” is similarly expected to have an inverse relationship with the quality of the network connection between the electronic device and the content server.

In one option, the step of the local electronic device selecting a content server from among a plurality of content servers from which to receive the requested content, includes the local electronic device selecting the content server that results in the shortest round trip time, the lowest hop count, or some combination of these parameters. These criteria for selection of the content server from which to receive the requested content, and optional further criteria, are used to determine that the local electronic device will have a better network connection with the selected content server than with any of the other identified content servers.

In another option, the local electronic device may determine local context parameters about a connection between the local electronic device and each of the identified content servers by testing the connection between the local electronic device and each of the identified content servers. For example, the local electronic device may test a connection with each of the identified content servers by transmitting a signal or message to each of the identified content servers and receiving a reply signal or message back from each of the identified content servers. The round trip time may be measured as the amount of time elapsing between transmitting the signal or message and receiving the reply signal or message. Alternative, the reply signal or message may identify each entity) receiving and retransmitting the reply signal or message, such that the hop count can be determined from the content of the reply signal or message.

Another embodiment of the present invention provides a computer program product comprising a non-transitory computer readable storage medium having program instructions embodied therewith, wherein the program instructions are executable by a processor to cause the processor to perform a method. The method comprises a local electronic device submitting a request to a service provider server for delivery of specific content to the local electronic device, the local electronic device receiving a reply from the service provider server identifying a plurality of content servers that can each deliver the requested content over a network, and the local electronic device determining one or more local context parameters about a network connection between the local electronic device and each of the identified content servers. The method further comprises the local electronic device selecting a content server from among the plurality of content servers from which to receive the requested content, wherein the selected content server is associated with a local context parameter indicating that the local electronic device has a better network connection with the selected content server than with any of the other identified content servers, and the local electronic device downloading the requested content from the selected content server.

The foregoing computer program products may further include program instructions for implementing or initiating any one or more aspects of the methods described herein. Accordingly, a separate description of the methods will not be duplicated in the context of a computer program product.

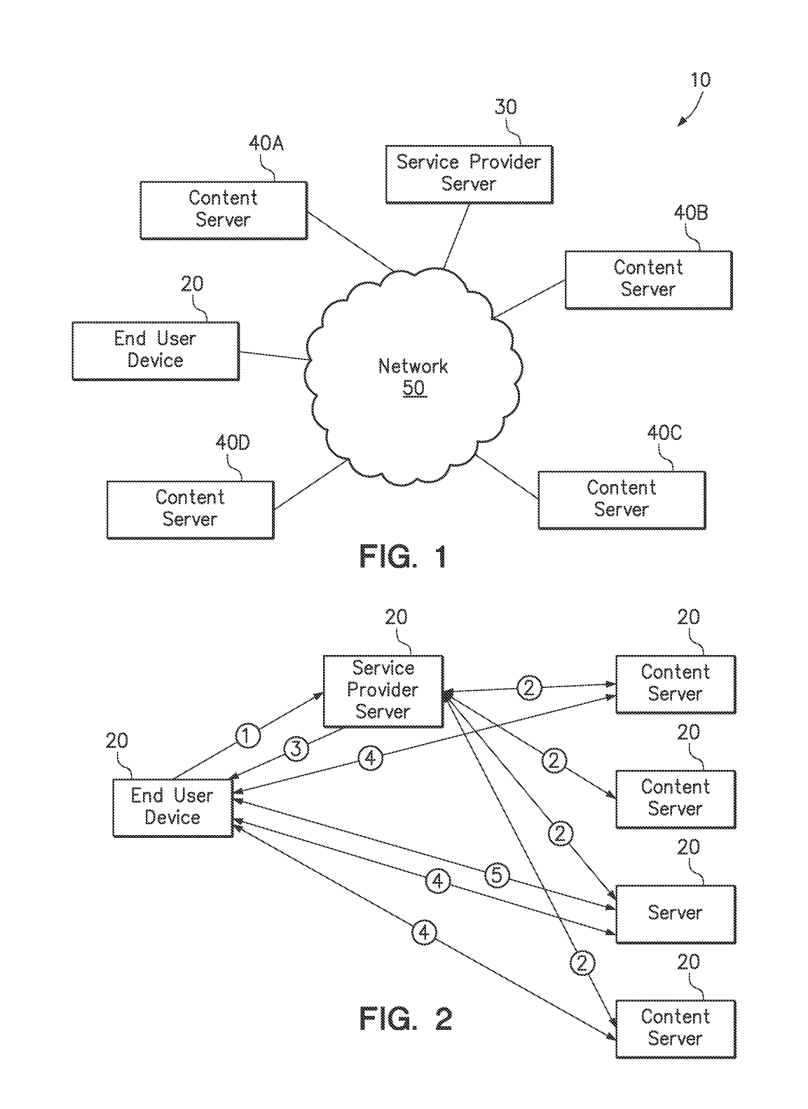

FIG. 1 is a diagram of a system 10 including an end user device (local electronic device) 20, a service provider server 30 and multiple content servers 40 in communication over a network 50, such as the Internet. Without limitation as to the network topology and protocols, the network may facilitate the communications, messages and signals that are involved in one or more embodiments of the present invention.

FIG. 2 is a diagram of the system 10 illustrating various communications between the end user (local electronic device) 10, the service provider server 30 and the) multiple content servers 40 according to one embodiment of the present invention. Each of the individual communications are numbered stepwise according to the order in which the communications occur. Simultaneous communications between any two entities or multiple sequential communications between the same two entities may be labeled as part of the same step. Each communication is labeled with a step number inside a circle that is superimposed upon a line illustrating the communication.

In step 1, the end user 20 (or local electronic device) requests a specific item of content via the service provider server 30. Optionally, the end user device may access an interface provided by the service provider server to facilitate selection of content for downloading.

In step 2, the service provider server 30 communicates with each of the content servers 40A-40D to gather server context parameters about all the content servers that have the requested content. For example, the service provider server 30 may send a request for a server context parameter and each content server 40A-40D may reply to the service provider with the requested server context parameter. For example, the service provide server may request and received a CPU load, memory load, network card load, or a number of active processes from each content server.

In step 3, the service provider 30 identifies a plurality of the content servers to the end user device (local electronic device) 20. For example, the service provider may provide the end user with a content server list including the first three content servers (out of a possible four content servers, in this example) that can deliver the requested content and that have the least amount of combined CPU load and memory load. Any multi criteria decision algorithm, without limitation, may be used for selecting the content servers that should be identified to the end user.

In step 4, the end user device (local electronic device) 20 obtains one or more local context parameter for each of the content servers 40A-40D identified in the list received from the service provider 30 in step 3. The one or more local context parameters may include, without limitation, a measure of “round trip time” between the end user device and a given content server, a “hop count” between the end user device and a given content server, and the rank of the content server in the list provided by the service) provider server. For example, the service provider server may rank the content servers according to one or more of the server context parameters.

In step 5, the end user device 20 selects one of the content servers 40A-40D from which to receive the requested content based on one or more of the local context parameters. For example, the end user device may automatically select the content server that results in the shortest round trip time, the lowest hop count, or some combination of these parameters. Since the determination of the content server that results in the shortest round trip time or lowest hop count, for example, may be different for each end user device, such determination is made by the end user device. Any multi criteria decision algorithm, without limitation, may be used for selecting the content server from which to receive the requested content. The requested content is then downloaded from the selected content server.

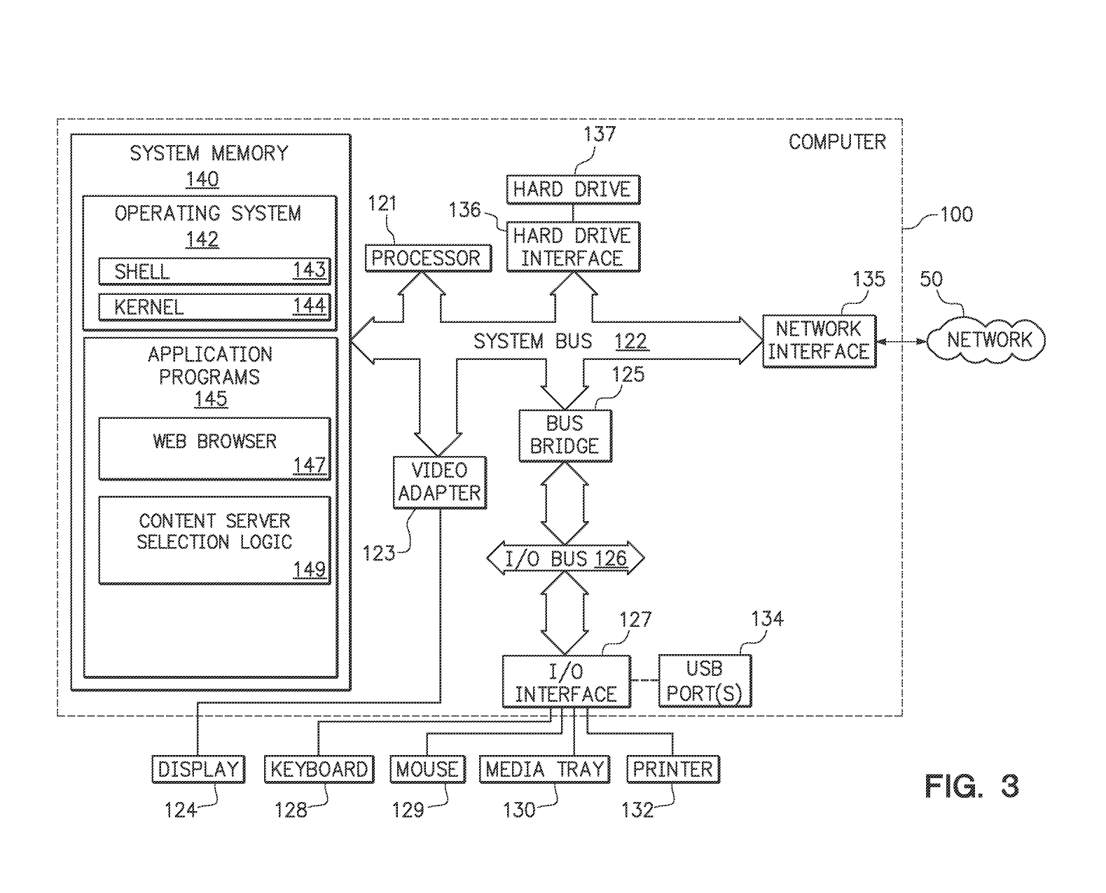

FIG. 3 is a diagram of a computer 100 capable of serving as the end user device 20, the server provider server 30, or any of the content servers 40A-40D according to one or more embodiments of the present invention. In this non-limiting example, the computer 100 includes a processor unit 121 that is coupled to a system bus 122. The processor unit 121 may utilize one or more processors, each of which has one or more processor cores. A video adapter 123, which drives/supports a display 124, may also be coupled to the system bus 122. The system bus 122 may also be coupled via a bus bridge 125 to an input/output (I/O) bus 126. Furthermore, an I/O interface 127 may be coupled to the I/O bus 126 to provide communication with various I/O devices, optionally including a keyboard 128, a mouse 129, a media tray 130 (which may include storage devices such as CD-ROM drives, multi-media interfaces, etc.), a printer 132, and/or USB port(s) 134. As shown, the compute node 100 is able to communicate with other network devices via the network 50 using a network adapter or network interface controller 135.

A hard drive interface 136 is also coupled to the system bus 122. The hard drive interface 136 interfaces with a hard drive 137. In a preferred embodiment, the hard drive 137 communicates with system memory 140, which is also coupled to the system bus 122. System memory includes the lowest level of volatile memory in the compute node 120. This volatile memory may include additional higher levels of volatile memory (not shown), including, but not limited to, cache memory, registers and buffers. Data that populates the system memory 140 includes the operating system (OS) 142 and application programs 145.

The operating system 142 includes a shell 143 for providing transparent user access to resources such as application programs 145. Generally, the shell 143 is a program that provides an interpreter and an interface between the user and the operating system. More specifically, the shell 143 executes commands that are entered into a command line user interface or from a file. Thus, the shell 143, also called a command processor, is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 144) for processing. Note that while the shell 143 may include a text-based, line-oriented user interface, the present invention will equally well support other user interface modes, such as graphical, voice, gestural, etc. As depicted, the operating system 142 also includes the kernel 144, which includes lower levels of functionality for the operating system 142, including providing essential services required by other parts of the operating system 142 and application programs 145, including memory management, process and task management, disk management, and mouse and keyboard management.

The hardware elements depicted in the computer 100 are not intended to be exhaustive, but rather are representative. For instance, the computer 100 may include alternate memory storage devices such as magnetic cassettes, digital versatile disks (DVDs), Bernoulli cartridges, and the like. These and other variations are intended to be within the scope of the present invention.

Where the computer 100 is serving as the end user device or local electronic device 20 (see FIGS. 1 and 2), The application programs 145 in the system memory of the computer 100 may include, without limitation, a web-browser 147 for rendering a graphical interface (website) provided by the service provider server to facilitate requests for specific content, and content server selection logic 149 in accordance with various embodiments of the present invention.

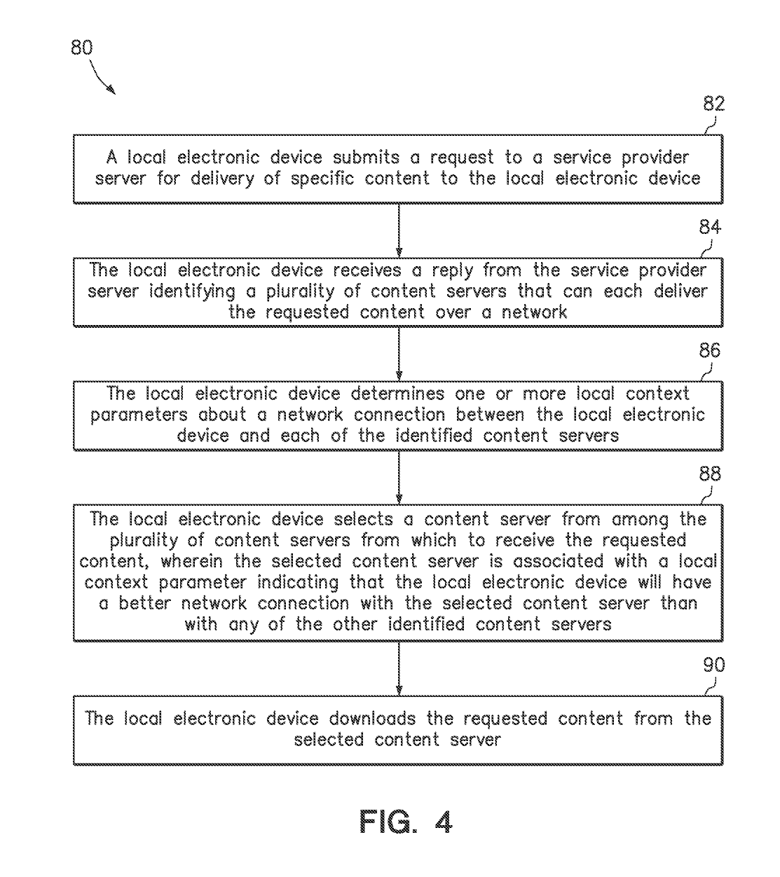

FIG. 4 is a flowchart of a method 80 according to an embodiment of the present invention. In step 82, a local electronic device submits a request to a service provider server for delivery of specific content to the local electronic device. In step 84, the local electronic device receives a reply from the service provider server identifying a plurality of content servers that can each deliver the requested content over a network. In step 86, the local electronic device determines one or more local context parameters about a network connection between the local electronic device and each of the identified content servers. In step 88, the local electronic device selects a content server from among the plurality of content servers from which to receive the requested content, wherein the selected content server is associated with a local context parameter indicating that the local electronic device has a better network connection with the selected content server than with any of the other identified content servers. In step 90, the local electronic device downloads the requested content from the selected content server.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable storage medium(s) may be utilized. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device. Furthermore, any program instruction or code that is embodied on such computer readable storage medium (including forms referred to as volatile memory) is, for the avoidance of doubt, considered “non-transitory”.

Program code embodied on a computer readable storage medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention may be described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, and/or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored as non-transitory program instructions in a computer readable storage medium that can direct a computer, other programmable data processing apparatus, or other devices to function in a particular manner, such that the program instructions stored in the computer readable storage medium produce an article of manufacture including non-transitory program instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless) the context clearly indicates otherwise. It will be further understood that the terms “comprises” and/or “comprising,” when used in this specification, specify the presence of stated features, integers, steps, operations, elements, components and/or groups, but do not preclude the presence or addition of one or more other features, integers, steps, operations, elements, components, and/or groups thereof. The terms “preferably,” “preferred,” “prefer,” “optionally,” “may,” and similar terms are used to indicate that an item, condition or step being referred to is an optional (not required) feature of the invention.

The corresponding structures, materials, acts, and equivalents of all means or steps plus function elements in the claims below are intended to include any structure, material, or act for performing the function in combination with other claimed elements as specifically claimed. The description of the present invention has been presented for purposes of illustration and description, but it is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method, comprising:
a local electronic device submitting a request to a service provider server for delivery of specific content to the local electronic device;
the local electronic device receiving a reply from the service provider server identifying a plurality of content servers that can each deliver the requested content over a network;
the local electronic device determining one or more local context parameters about a network connection between the local electronic device and each of the identified content servers;
the local electronic device selecting a content server from among the plurality of content servers from which to receive the requested content, wherein the selected content server is associated with a local context parameter indicating that the local electronic device has a better network connection with the selected content server than with any of the other identified content servers; and
the local electronic device downloading the requested content from the selected content server.

2. The method of claim 1, wherein the reply from the service provider server identifies one or more content servers that can each deliver the requested content and that have a lower load than other content servers that can deliver the requested content.

3. The method of claim 2, wherein the load on a content server is indicated by a parameter selected from CPU load, memory load, network card load, and a number of active processes.

4. The method of claim 3, wherein the selected content server is associated with a local context parameter and a server load parameter indicating that the local electronic device has a better network connection with the selected content server than with any of the other identified content servers

5. The method of claim 1, further comprising:
the local electronic device obtaining a server context parameter for each of the plurality of content servers.

6. The method of claim 5, wherein the local electronic device receives the server context parameter for each of the plurality of content servers from the service provider server.

7. The method of claim 1, wherein the one or more local context parameters are selected from a measure of “round trip time” between the local electronic device and the content server, a “hop count” of devices between the local electronic device and the content server, and a combination thereof.

8. The method of claim 1, wherein the local electronic device selecting a content server from among a plurality of content servers from which to receive the requested content, includes the local electronic device selecting the content server that results in the shortest round trip time, the lowest hop count, or some combination of these parameters.

9. The method of claim 1, wherein the local electronic device determining local context parameters about a connection between the local electronic device and each of the identified content servers, includes the local electronic device testing the connection between the local electronic device and each of the identified content servers.

10. The method of claim 1, wherein the local electronic device is an individual computing device.

11. A computer program product comprising a non-transitory computer readable storage medium having program instructions embodied therewith, the program instructions executable by a processor to cause the processor to perform a method comprising:
a local electronic device submitting a request to a service provider server for delivery of specific content to the local electronic device;
the local electronic device receiving a reply from the service provider server identifying a plurality of content servers that can each deliver the requested content over a network;
the local electronic device determining one or more local context parameters about a network connection between the local electronic device and each of the identified content servers;
the local electronic device selecting a content server from among the plurality of content servers from which to receive the requested content, wherein the selected content server is associated with a local context parameter indicating that the local electronic device has a better network connection with the selected content server than with any of the other identified content servers; and
the local electronic device downloading the requested content from the selected content server.

12. The computer program product of claim 11, wherein the reply from the service provider server identifies one or more content servers that can each deliver the requested content and that have a lower load than other content servers that can deliver the requested content.

13. The computer program product of claim 12, wherein the load on a content server is indicated by a parameter selected from CPU load, memory load, network card load, and a number of active processes.

14. The computer program product of claim 13, wherein the selected content server is associated with a local context parameter and a server load parameter indicating that the local electronic device has a better network connection with the selected content server than with any of the other identified content servers

15. The computer program product of claim 11, the method further comprising:
the local electronic device obtaining a server context parameter for each of the plurality of content servers.

16. The computer program product of claim 15, wherein the local electronic device receives the server context parameter for each of the plurality of content servers from the service provider server.

17. The computer program product of claim 11, wherein the one or more local context parameters are selected from a measure of “round trip time” between the local electronic device and the content server, a “hop count” of devices between the local electronic device and the content server, and a combination thereof.

18. The computer program product of claim 11, wherein the local electronic device selecting a content server from among a plurality of content servers from which to receive the requested content, includes the local electronic device selecting the content server that results in the shortest round trip time, the lowest hop count, or some combination of these parameters.

19. The computer program product of claim 11, wherein the local electronic device determining local context parameters about a connection between the local electronic device and each of the identified content servers, includes the local electronic device testing the connection between the local electronic device and each of the identified content servers.

20. The computer program product of claim 11, wherein the local electronic device is an individual computing device.
